(19) United States
(12) Patent Application Publication
(10) Pub. No.: US 2011/0041370 A1
(43) Pub. Date: Feb. 24, 2011

(54) FACE SHEET, IDENTIFICATION BAND, AND RELATED METHODS

(76) Inventors: Andre M. Saint, Getzville, NY (US); Stanley J. Serwon, Newstead, NY (US); Rosalyn R. Ben-Chitrit, Woodbridge, CT (US); Anne M. Dehlinger, Pendleton, NY (US); William Becker, Lockport, NY (US)

Correspondence Address: AVERY DENNISON CORPORATION;Patent Group, Law Department - 3 South, P.O. BOX 7090, PASADENA, CA, 91109-7090, US

(21) Appl. No.: 12/877,894

(22) Filed: Sep. 8, 2010

Related U.S. Application Data
(63) Continuation-in-part of application No. 11/111,539, filed on Apr. 21, 2005, now Pat. No. 7,810,267.

(51) Int. Cl. A44C 5/00; B05D 5/12; D03D 15/00; D04H 13/00; B32B 9/04; B32B 27/36; B32B 27/32; B32B 27/00; G06K 19/067

(52) U.S. Cl. 40/633; 427/58; 442/181; 442/327; 428/411.1; 428/480; 428/500; 235/492

(57) ABSTRACT

A face sheet including a substrate layer and a layer that is coupled to the substrate layer and configured to facilitate thermal printing or inkjet printing. The substrate layer is made of a woven material, a non-woven material, or a film material.

### CROSS REFERENCE TO RELATED PATENT APPLICATION

This is a continuation-in-part of U.S. patent application Ser. No. 11/111,539, filed on Apr. 21, 2005, entitled “Patient Identification Products,” by Andre M. Saint, Stanley J. Serwon, Rosalyn R. Ben-Chitrit, and Anne Runfola, which is incorporated by reference herein in its entirety. Accordingly, priority is claimed under 37 C.F.R. §120 to U.S. patent application Ser. No. 11/111,539.

### FIELD OF THE INVENTION

The invention relates to face sheets and patient identification products, including wristbands, anklebands, identification cards, and labels, and related methods.

### BACKGROUND

Hospitals and other healthcare facilities are acutely aware of problems associated with improper identification and tracking of patients. These concerns extend to carefully and correctly identifying specimens taken from a patient for analysis and carefully matching medicine for administration to a patient. With infants, the concerns also extend to properly matching parents with the correct infant.

Identification bands for the wrist and/or ankle typically are applied to a patient as part of the hospital admission process. The typical identification band is imprinted with the name of the patient and other relevant data, and sometimes is imprinted with a machine readable barcode. The barcode and at least some of the other data on the identification bracelet also may be imprinted on labels that are used periodically through the patient's stay in a healthcare facility. For example, a label can be applied to documentation that goes into a chart that is associated with the patient's care. Labels may be applied to specimen collection tubes and the results of diagnostic tests performed on collected specimens will be routed physically or electronically based on data imprinted on the labels. Doses of medication typically are prepared by medical or pharmacy personnel and may be placed in containers that bear labels with barcodes. The healthcare provider may carry a barcode reader and will scan both the medicine container and the patient's identification band prior to administering a drug to ensure conformance. The patient's identification band also will be checked visually or by machine before performing any medical procedure.

The information printed on a patient's identification band and information printed on labels associated with the patient's identification band typically is stored in the memory of a computer. The patient's identification band and labels associated with the identification band are printed by a printer associated with the computer. The printer may be an inkjet printer, a laser printer or the like. Accordingly, the identification bands should be formed in a manner that will ensure efficient processing through a printer.

Identification bands and other identification material employed in a healthcare facility may be exposed to liquids and may be subjected to physical contact. The printed information must remain readable despite periodic moistening and contact. Accordingly, some identification bands are laminated structures with a clear plastic overlay secured on a substrate that bears the printed indicia. Laminated identification bands may require complex, time consuming manipulation by the healthcare worker.

Some patients remain in a healthcare facility for an extended time, and many of these patients have sensitive skin. For example, prematurely born infants may spend several weeks or months in a healthcare facility while they are being monitored, nourished and treated. A significant portion of this stay could be in a neonatal intensive care unit (NICU). These small babies often are visually indistinguishable from one another and are incapable of identifying themselves. Additionally, infants in a neonatal intensive care unit may have a specified regimen of nourishment and medication requirements based on their own individual fragile conditions. Accordingly, proper identification is essential. However, conventional identification bands are fairly rigid due to the thickness and stiffness of the materials and can easily irritate the skin of a small baby. Skin irritations or abrasions may require treatment and can complicate the extended stay of a premature baby in the neonatal intensive care unit. A similar problem can arise with elderly patients who may be required to stay an extended time in a healthcare facility.

Healthcare facilities also are concerned with security in and around the maternity ward and the neonatal care units. Accordingly, many hospitals require the parents to wear wristbands corresponding to the identification band worn by the baby. These parental wristbands place controls on the number and identity of people to whom the baby will be exposed and address security concerns of the healthcare facility. The parental wristbands desirably are printed automatically from the information stored in the computer and most preferably are printed simultaneously with identification band of the infant. As RFID technology grows and becomes mainstream, the use of this technology within an identification band creates the ability to track location or movement of patients within a facility, as well as enable dynamic collection and storage of other relevant information, increasing security.

In view of the above, it should be appreciated that there is a need for the following: an identification band that can be worn comfortably by a patient for an extended time; an identification band that is well suited for infants, and particularly prematurely born infants, and elderly patients; an identification band that can withstand exposure to moisture and contact without affecting the ability to read, via RF, optical scan, or the like, the information presented thereon; an identification assembly for simultaneously printing several identification tools including at least one wristband or ankleband; and an identification band that can be applied and used easily by healthcare workers. The present invention satisfies these needs.

### SUMMARY

The invention relates to an identification band suitable for carrying and displaying indicia and suitable for being worn on the wrist or ankle of an infant or other person. The identification band is formed from a thin flexible layer of woven material, and preferably is formed from a material that will permanently and clearly display indicia imparted thereon by a commercially available printer, such as a laser printer, inkjet printer, thermal printer or the like. The woven material preferably is a woven synthetic fabric, such as polyester or nylon. Additionally, the woven fabric can be impregnated with a compatible synthetic material that will substantially fill voids between the woven fibers of the fabric to define a sufficiently continuous and smooth surface for receiving and displaying printed indicia. The synthetic material impregnated into the woven fabric can be a polyester, styrene, acrylic or other compatible organic-based material. The identification band in accordance with the invention preferably is sufficiently thin and flexible to avoid irritating sensitive skin. For example, a sheet material with a thickness of about 3.0-6.0 mils is preferred, and most preferably the material has a thickness of about 4.0 mils.

Identification bands in accordance with the present invention are particularly well suited for infants, children and especially for prematurely born infants who will remain in a healthcare facility for several days, weeks or months. Narrow-width bands are especially well suited for the small wrists or ankles of infants. However, a narrow band may not have sufficient dimensions for receiving all of the identification information that is required. As a result, the identification band includes a narrow strap and an identification panel. The strap is sufficiently wide to provide the necessary strength and to prevent biting into the wrist or ankle of the patient. Additionally, the strap preferably is wide enough to prevent twisting during normal use. A strap of about 1 cm wide is sufficient for these purposes. The identification panel is sufficiently wide and long to accommodate the identification indicia that may be required. For example, an identification panel with a width of about 2-3 cm and a length of about 5 cm is sufficiently large to convey the required indicia with adequate size and clarity. The identification panel preferably is unitary with one longitudinal end of the strap, and preferably is free of sharp corners. The identification panel includes a top surface on which the identification indicia can be printed and an opposite back surface. The back surface need not be printed with identification indicia.

The identification band can further include a flap joined unitarily to the identification panel along a fold line that preferably is substantially parallel to the longitudinal direction of the strap. The flap preferably is the same size and shape as the identification panel and has opposite top and back surfaces. The top surface of the flap can be printed with the same or additional identification indicia as the top surface of the identification panel.

A layer of pressure sensitive adhesive is applied to the back surface of the flap and/or the back surface of the identification panel. With this construction, the strap can be formed into a loop so that a section of the strap is placed in face-to-face engagement with the back surface of the identification panel. The flap then is folded so that the back surface of the flap overlies the back surface of the identification panel and sandwiches a portion of the strap between the back surfaces of the identification panel and the flap. The adhesive applied to the back surface of the flap and/or the identification panel will securely retain the strap in its looped condition to form a continuous identification band. Although the strap is appropriately narrow for an infant, the identification panel is sufficiently large to bear the required identification indicia. Additionally, identification indicia on the flap will ensure that the identification data are easily readable even if the identification band becomes twisted slightly while worn. RFID HF or UHF inlay (for example TAG IT provided by Texas instruments of Dallas, Tex., or UHF provided by Avery Dennison Corporation of Pasadena, Calif.) also can be inserted during manufacturing to reside between the laminate layers or separate from the band of which the inlay label would be affixed prior to folding, thereby securing the inlay safely, securely and permanently between or on topside of the folds. In addition, the compressible nature of the woven fabric provides a protective cushion around the RFID to help it resist damage and can be made waterproof to further protect the identification band or RFID inlay as well.

An aspect of the invention is the ability to print the identification band efficiently and reliably in a laser printer, thermal, an inkjet printer or other commercially available printing apparatus. Printers work best when the printed sheets are relatively thin and have uniform thickness or coplanarity across the length and width of the sheet. Sheets that are too thick may not feed well through many machines and sheets that do not exhibit coplanarity across the sheet are likely to jam in the feed mechanisms of the printer.

The identification band of the present invention preferably is part of a laminated sheet assembly that includes a face sheet and a backing sheet. The face sheet can be formed from the above-described sheet of woven fibers, such as polyester or nylon. The face sheet has a top surface on which the indicia are imprinted and a back surface that requires no indicia. The backing sheet can be formed from a paper material with opposite top and back surfaces. The top surface of the backing sheet is secured at least temporarily in face-to-face engagement with the back surface of the face sheet.

The face sheet is provided with at least one array of die cuts to define the preferred shape for the identification band. The die cuts are dimensioned to hold the identification band as part of the entire face sheet as the laminated sheet assembly is being processed through a printer.

A major part of the back surface of the face sheet can have a thin coat of pressure sensitive adhesive applied thereto. However, there preferably is no adhesive applied to portions of the back surface of the face sheet that will define the strap of the identification band. The top surface of the backing sheet preferably has a thin release coat applied to portions of the backing sheet that will register with the identification panel and flap of the identification band. However, the release coat preferably is disposed at locations spaced inwardly from the outer periphery of the backing sheet. The backing sheet further includes an array of low-tack adhesive, breakaway or dry release coatings on portions of the top surface of the backing sheet that will register with the strap of the identification band. The low-tack adhesive will hold the strap of the identification band releasably to the backing sheet as the laminated sheet assembly is being processed through a printer. However, the strap can be separated easily from the low-tack adhesive, breakaway or dry release coatings and the low-tack adhesive or the like will not be transferred to the strap.

The laminated sheet assembly can include an indicia bearing card that can be slid into, or affixed to utilizing a removable pressure sensitive adhesive, a mounting frame on a crib, isolette, basinet, bed or the like to identify the patient and/or his/her treatment area. Portions of the back surface of the face sheet that correspond to an identification card can have the pressure sensitive adhesive applied thereto, and the opposed top surface of the backing sheet preferably has no release coating and no low-tack adhesive breakaway or dry release coatings applied thereto. Hence, the identification card defined by the face sheet will be secured substantially permanently to corresponding portions of the backing sheet for added structural support and integrity. Embodiments that have an identification card preferably have die cuts that extend through both the face sheet and the backing sheet around the periphery of the identification card.

The laminated sheet assembly can further define at least one adhesive backed label that can be applied to a bottle of milk or formula. The label is defined by an array of die cuts in the face sheet. Patient-identifying indicia can be printed on the top surface of the face sheet within the area bounded by the array of die cuts that define the label. A pressure sensitive adhesive is applied to portions of the back surface of the face sheet corresponding to the label. A release coat preferably is applied to the top surface of the backing sheet opposed to the label. With this construction, the label can be removed along the die cuts from the remainder of the face sheet and peeled from the backing sheet. The label then can be secured to a substrate, such as a bottle.

An exemplary embodiment of the present invention is a face sheet that includes a substrate layer and a layer that is coupled to the substrate layer and is configured to facilitate printing, for example, thermal printing or inkjet printing. The substrate layer is made of a woven material, a non-woven material, and/or a film material.

In other, more detailed features of the invention, the face sheet is characterized as having a soft texture. Also, the substrate layer material can be polyethylene terephthalate, a biaxially oriented polypropylene, a vinyl, a polyolefin, a polyester, a nylon, or a blend thereof. In addition, the layer that is configured to facilitate thermal printing can be a an inkjet layer or a thermal coating layer. Furthermore, the thermal coating layer can be made of a liquid that is a low-solids water, a solvent borne liquid, and/or a solventless borne liquid, and the liquid can include a mixture of a dye, a sensitizer, and a developer.

In other, more detailed features of the invention, the face sheet also includes a topcoat layer that is coupled to the layer that is configured to facilitate printing with the layer that is configured to facilitate printing coupled between the topcoat layer and the substrate layer. Also, the topcoat layer can be made of water, a solvent liquid, a solventless liquid, a solvent-borne acrylic, and/or a solvent-borne silicone.

In other, more detailed features of the invention, the face sheet also includes an additional coating layer that is coupled to the top coat layer with the topcoat layer coupled between the additional coating layer and the layer that is configured to facilitate printing. The additional coating layer can be made of a water-based material, a solvent-borne acrylic, and/or a solvent-borne silicone. Also, the face sheet can further include a primer layer that is coupled between the substrate layer and the layer that is configured to facilitate printing.

In other, more detailed features of the invention, the face sheet also includes a film layer, where the layer that is configured to facilitate printing is included in the film layer. Also, the face sheet can include an adhesive layer that is coupled between the film layer and the substrate layer. The film layer can be made of a polyester, a polypropylene, TF-100™, or TF-160™. In addition, the coating layer can be UV curable. Also, the layer that is configured to facilitate printing can be a thermally activatable coating layer, and the film layer can include another layer that is a print-receptive coating layer or a barrier coating layer.

In other, more detailed features of the invention, the substrate layer extends beyond the layer that is coupled to the substrate. Also, the face sheet can be part of an item, e.g., an identification band, an identification card, a label, and a tag. In addition, the item can include an RFID component, e.g., an RFID inlay and an RFID label. Also, the face sheet can be part of an identification band that has at least one edge that is uneven. Furthermore, the face sheet can be configured into a sheet, a z-fold stack of sheets, or a roll of material.

Another exemplary embodiment is an identification band that includes a piece of face sheet, a piece of backing sheet, and a layer of adhesive that is coupled between the face sheet and the piece of backing sheet. The piece of face sheet includes a substrate layer, and a layer that is coupled to the substrate layer and is configured to facilitate printing. The substrate layer is made of a woven material, a non-woven material, and/or a film material.

An exemplary method according to the invention is a method for forming a face sheet. The method includes providing a substrate material, providing a second material, e.g., a thermally activatable material or an inkjet material, forming a substrate layer from the substrate material, and forming a second layer from the second material. The second layer is adjacent to the substrate layer, and is configured to facilitate printing. The substrate material is a woven material, a non-woven material, and/or a film material.

In other, more detailed features of the invention, the step of forming the second layer from the second material includes depositing the second material on the substrate layer. Also, the method can further include providing a topcoat material, and forming a topcoat layer from the topcoat material adjacent to the second layer. In addition, the method can further include providing an additional coating material, and forming an additional coating layer from the additional coating material adjacent to the topcoat layer.

Another exemplary method according to the invention is another method for forming a face sheet. The method includes providing a substrate material, forming a substrate layer from the substrate material, providing a film layer having a thermally activatable coating layer, and coupling the film layer to the substrate layer. The thermally activatable coating layer is configured to facilitate thermal printing. The substrate material is a woven material, a non-woven material, and/or a film material. In other, more detailed features of the invention, the step of coupling the film layer to the substrate layer includes providing an adhesive material, forming an adhesive layer from the adhesive material, and coupling the adhesive layer between the film layer and the substrate layer.

Other features of the invention should become apparent to those skilled in the art from the following description of the preferred embodiments taken in conjunction with the accompanying drawings, which illustrate, by way of example, the principles of the invention, the invention not being limited to any particular preferred embodiment(s) disclosed.

### BRIEF DESCRIPTION OF THE DRAWINGS

These and other features, aspects, and advantages of the present invention will become better understood with reference to the following description, appended claims, and accompanying drawings, where:

FIG. 1 is an exploded perspective view of a laminated sheet assembly in accordance with an embodiment of the invention.

FIG. 2 is a bottom plan view of the face sheet shown in FIG. 1.

FIG. 3 is a perspective view of the sheet assembly showing an identification band in the process of being removed from the laminated sheet assembly shown in FIG. 1.

FIG. 4 is a top plan view of the identification band of FIG. 3 prior to being formed into a loop.

FIG. 5 is a bottom plan view of the identification band in the planar orientation shown in FIG. 4.

FIG. 6 is a top plan view of the identification band of FIG. 4 after being formed into a loop but prior to being placed in its final condition.

FIG. 7 is a top plan view of the identification band of FIG. 6 in one possible final condition.

FIG. 8 is a front elevational view of the identification band shown in FIG. 7.

FIG. 9 is a perspective view of the identification band of FIG. 4 showing another possible orientation for placement on a patient.

FIG. 10 is a front elevational view of the identification band of FIG. 9 in its fully assembled condition.

FIG. 11 is a top plan view of a laminated sheet assembly in accordance with another embodiment of the invention.

FIG. 12 is a perspective view of a sheet assembly showing an alternate identification band in accordance with another embodiment of the present invention in the process of being removed.

FIG. 13 is a bottom plan view of a further alternate identification band in the planar orientation according to another embodiment of the present invention.

FIG. 14 is a sectional view of a laminated sheet assembly according to an embodiment of the invention.

FIG. 15A is a top plan view of an identification band that is rectangular in shape according to an embodiment of the invention.

FIG. 15B is a top plan view of an identification band that has a non-rectangular shape according to another embodiment of the invention.

FIG. 16 is a sectional view of a face sheet according to an embodiment of the invention.

FIG. 17 is a sectional view of a face sheet including an additional coating layer according to an embodiment of the invention.

FIG. 18 is a flowchart of an example method for forming a face sheet according to the invention.

FIG. 19 is a sectional view of a face sheet including a film layer according to an embodiment of the invention.

FIG. 20 is a flowchart of another example method for forming a face sheet according to the invention.

FIG. 21 is a sectional view of an embodiment of the film layer of FIG. 19.

FIG. 22 is a sectional view of another embodiment according to the invention of the film layer of FIG. 19.

FIG. 23 is a sectional view of another embodiment according to the invention of the film layer of FIG. 19.

FIG. 24 is a top plan view of an embodiment of a face sheet where the substrate extends beyond edges of the film layer.

FIG. 25 is a top plan view of another embodiment according to the invention of an identification band that is rectangular in shape and has uneven edges.

FIG. 26 is a side elevational view of a roll of material according to an embodiment of the invention.

FIG. 27 is a side elevational view of a z-fold stack of sheets according to an embodiment of the invention.

FIG. 28 is a sectional view of a face sheet according to another embodiment of the invention where the face sheet includes an inkjet layer.

FIG. 29 is a sectional view of a face sheet according to another embodiment of the invention where the face sheet includes an inkjet layer and a primer layer.

Unless otherwise indicated, the illustrations in the above figures are not necessarily drawn to scale.

### DETAILED DESCRIPTION

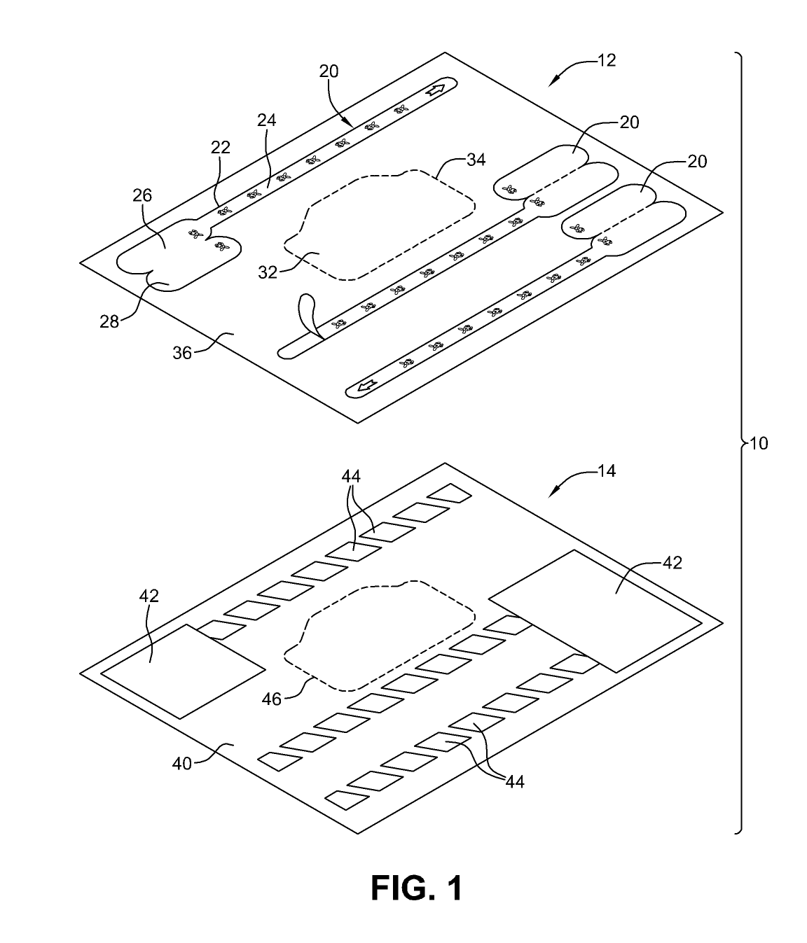

A sheet assembly in accordance with the present invention is identified generally by the numeral 10 in FIG. 1. The sheet assembly 10 includes a face sheet 12 and a backing sheet 14. The face sheet is substantially rectangular and can be formed from a woven material, such as polyester, that has been impregnated with a compatible filler, such as polyester or nylon. The filler is applied sufficiently to define a relatively smooth continuous surface that will accept and retain printed indicia. The face sheet preferably defines a thickness of about 5 mils.

A plurality of identification bands 20 are defined on the face sheet 12 by a corresponding plurality of arrays of die cuts 22. The die cut arrays can be die cut, laser cut or otherwise formed to extend through the face sheet at a plurality of spaced apart locations thereon. The specific dimensions of the die cut arrays can vary depending upon the characteristics of the material from which the face sheet is formed. However, the die cut arrays should be formed to permit separation of the identification bands from the face sheet without excessive manipulation or force and without tearing either the identification bands or adjacent areas of the face sheet. In a preferred embodiment, each die cut is a continuous die cut around the complete perimeter of all bands, cards, or labels. The length of each die cut and the lengths of the ties between die cuts will vary in accordance with the characteristics of the material from which the face sheet is formed.

Each identification band 20 includes a strap 24, an identification panel 26, and a flap 28. The strap has a width of about 1.0 cm and length of about 18 cm to about 24 cm. The identification panel is generally an ellipse or oblong with rounded corners defining a radius of about 0.75 cm to about 1.50 cm. The rounded corners are not likely to irritate skin and minimize the risk of tearing when the identification band is being separated from the remainder of the face sheet 12. The identification panel is sufficiently large to display the required information. A preferred identification panel has a length of about 5.0 cm and a width of about 2.0 cm to about 3.0 cm. The strap extends substantially symmetrically from a narrow end of the identification panel. Referring additionally to FIG. 4, the flap is joined unitarily to the identification panel along a fold line 30 that is aligned substantially parallel to the longitudinal direction of the strap. The fold line is shorter than the identification panel and the flap and terminates at well defined concave cusps to facilitate precise folding.

The face sheet 12 of the illustrated embodiment further includes an identification card 32 formed by an array of die cuts 34. The identification card is generally rectangular, but includes a tab extending from one long side thereof.

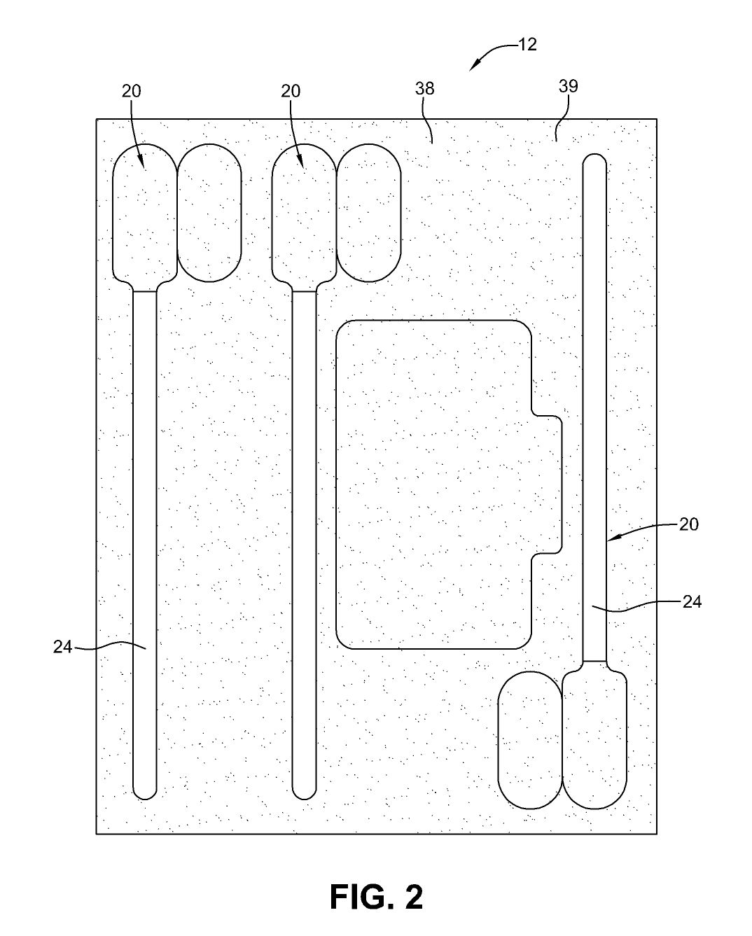

The face sheet 12 includes a top surface 36 as shown in FIG. 1 and an opposite back surface 38 as shown in FIG. 2. The top surface of the face sheet is imprinted with patient-specific indicia at locations corresponding to the identification panel 26, the flap 28, and the identification card 32.

The back surface 38 of the face sheet 12 is provided with a thin layer of adhesive 39 applied to substantially all regions of the back surface except for areas of the back surface within portions of the die cut array 22 that define the strap 24 of the identification band 20. The pressure sensitive adhesive has a composition that will remain stable and not flow when subjected to temperatures as high as 300° F. to 400° F. to facilitate printing of the sheet assembly 10 in a laser printer or other high temperature printing apparatus. The adhesive also should not degrade easily when exposed to ultra-violet light. In this regard, exposure to ultra-violet light during normal use of the components of the sheet assembly should not turn the adhesive yellow or cause the adhesive to lose its tackiness. One such adhesive is described in U.S. Pat. No. 5,262,216 to Popat et al., the disclosure of which is incorporated herein by reference in entirety. A preferred adhesive is the P32™ hot melt adhesive which is available from Avery Dennison Corporation. The pressure sensitive adhesive typically will have a thickness in the range of about 0.25 mils to about 2.0 mils.

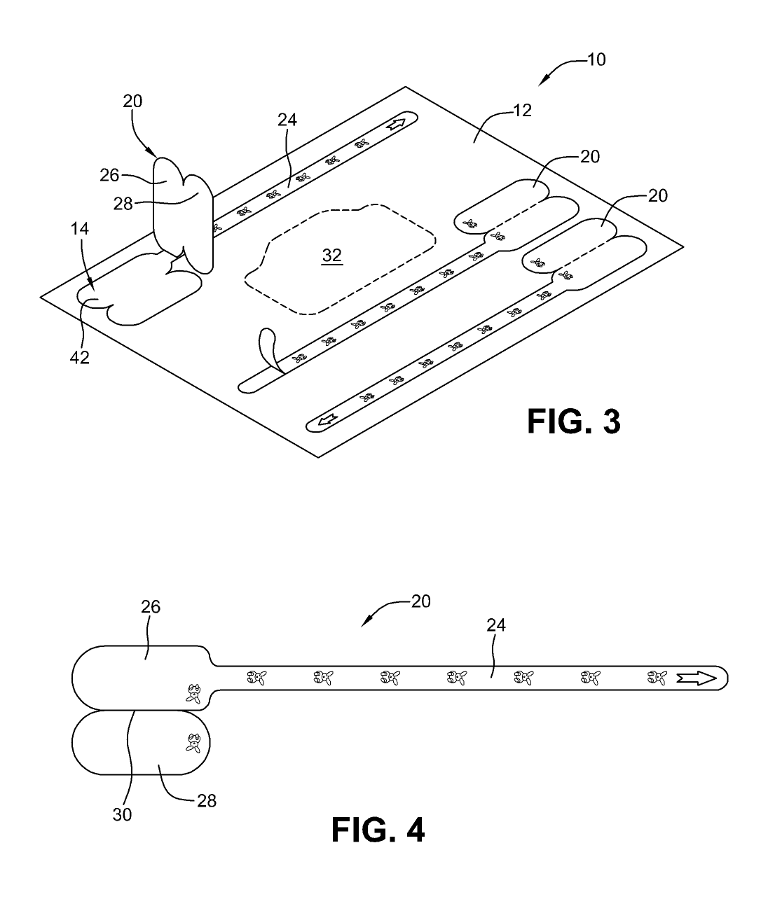

The backing sheet 14 is substantially rectangular and conforms to the size and shape of the face sheet 12. The backing sheet can be any flexible paper or film. Preferably, however, the backing sheet is a paper sheet with a thickness selected so that the sheet assembly 10 can be processed efficiently through a conventional sheet-fed printer, such as a laser printer or ink jet printer. Currently available printers can process sheets with a thickness of 15 mils or less. A backing sheet with a thickness of 2 mils to 6 mils would provide sufficient support for the sheet assembly while still permitting efficient processing through a conventional printing apparatus. The backing sheet has a top surface 40 as shown in FIGS. 1 and 3 and an opposite back surface. A release coating 42 is applied to areas of the top surface of the backing sheet that will register with the identification panel 26 and the flap 28. The release coating preferably is a conventional silicone composition, but other release compositions, such as fluorinated or amine-based release compositions can be used. The release coating can be extremely thin, e.g., in the range of about 0.1 mil to 0.5 mil. Additionally, a low-tack adhesive, breakaway or clean release 44 is applied to areas of the top surface of the backing sheet that will register with the strap 24 of the identification band 20. The low-tack adhesive 44 can extend continuously in opposed relationship to the strap. However, in the illustrated embodiment, the low-tack adhesive is applied at locations spaced from one another along the length of the strap. The dimensions of each discrete region of low-tack adhesive on the top surface of the backing sheet exceed the dimensions of the spacing between the sections of low-tack adhesive. The spacing is selected to ensure that the strap will be retained on the backing sheet as the sheet assembly is being processed through a printer. However, the extent and characteristics of the low-tack adhesive breakaway or clean release areas 44 should not lead to difficulties in separating the strap from the backing sheet. Additionally, the spacing between the areas of low-tack adhesive breakaway or clean release should not create significant surface discontinuities across the laminated sheet in a way that could affect the coplanarity of the laminated sheet. Areas of the top surface of the backing sheet spaced from the identification band have no release coating and no low-tack adhesive breakaway or clean release.

The backing sheet 14 further includes an array of die cuts 46 that will substantially register with the die cuts 34 that define the identification card 32. Thus, the die cuts 46 on the backing sheet define an identification card support conforming to the size and shape of the identification card.

The back surface 38 of the face sheet 12 can be registered with, and secured to, the top surface 40 of the backing sheet 14 to form the sheet assembly 10. The sheet assembly then can be processed through a printer, such as a laser printer, thermal, or inkjet printer to print patient specific indicia on at least the identification panel 26 of each identification band 20 and on the identification card 32. Patient specific indicia also can be printed on portions of the top surface 36 of the face sheet defining the flap 28.

The identification band 20 is used by flexing the laminating sheet assembly 10 near the identification band to sever either the strap 24 or the identification panel 26 from peripheral regions of the face sheet 12 outside of the die cut array 22. As a result, the face sheet will sever along the die cut array. The identification panel and the flap 28 can be peeled easily from the backing sheet 14 due to the release coating 42 applied to portions of the top surface 40 of the backing sheet registered with the identification panel and the flap. The healthcare worker then continues to pull the identification panel, as shown in FIG. 3, to sever the strap from remaining areas of the face sheet and to peel the strap from the backing sheet. The die cut array permits clean severance of the strap without excessive force or tearing. Additionally, portions of the bottom surface 38 of the face sheet corresponding to the strap have no adhesive thereon, and the low-tack adhesive regions 44 will not significantly impede the intentional peeling of the strap from the backing sheet.

The completely separated identification band 20 (see FIG. 4) can be wrapped around the wrist or ankle of the patient, and a portion of the top surface 36 along the strap 24 is placed in face-to-face engagement with a portion of the back surface 38 defining the identification panel 26. The adhesive 39 on the back surface of the identification panel will retain the adjacent area of the strap in face-to-face engagement with the identification panel. This positioning is carried out to ensure that the identification band does not inadvertently slide off the wrist or ankle, while avoiding a tight constricting fit. Mounting is completed by rotating the flap 28 about the fold line 30 and tucking the flap under the identification panel. The fold line is shorter than the longitudinal dimensions of the identically configured identification panel and flap. The flap then is secured in face-to-face registration with the back surface of the identification panel. Hence, the strap is sandwiched securely between the identification panel and the flap. Any excess of the strap that may extend beyond the identification panel can be trimmed.

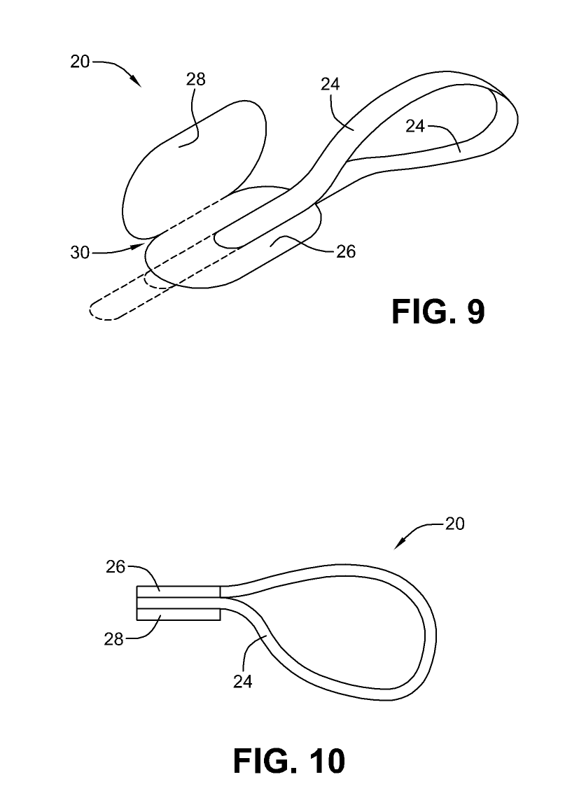

The identification band 20 shown in FIGS. 6-8 generally resembles a wristwatch or watchband. However, the identification band can be mounted on the patient so that the identification panel 26 and the flap 28 define a flag as shown in FIGS. 9 and 10. In this regard, the back surface 38 adjacent the free end of the strap 24 is placed on the back surface of the identification panel. The flap then is rotated about the fold line 30 and into secure face-to-face registration with the back surface of the identification panel. Thus, the strap is sandwiched securely between the identification panel and the flap. However, the identification panel and the flap project transversely from the wrist or ankle of the patient in much the same manner as a flag. The flag arrangement of the identification panel and the flap is easier to achieve and can be easier to read in many situations.

The identification band 20 is soft and flexible to avoid irritating the skin of a patient, such as a prematurely born infant who may require monitoring, nourishment and treatment for an extended time in the healthcare facility. However, the soft flexible woven identification band, especially when the identification band includes woven material, exhibits excellent strength and is not likely to tear in response to forces exerted during normal usage. The strap 24 is sufficiently wide to lie in face-to-face engagement with the skin of the patient without twisting. The identification panel 26 is sufficiently large to bear all required indicia. Furthermore, synthetic woven material, if used, of the identification band will retain the printed indicia applied thereto despite exposure to fluid and/or contact.

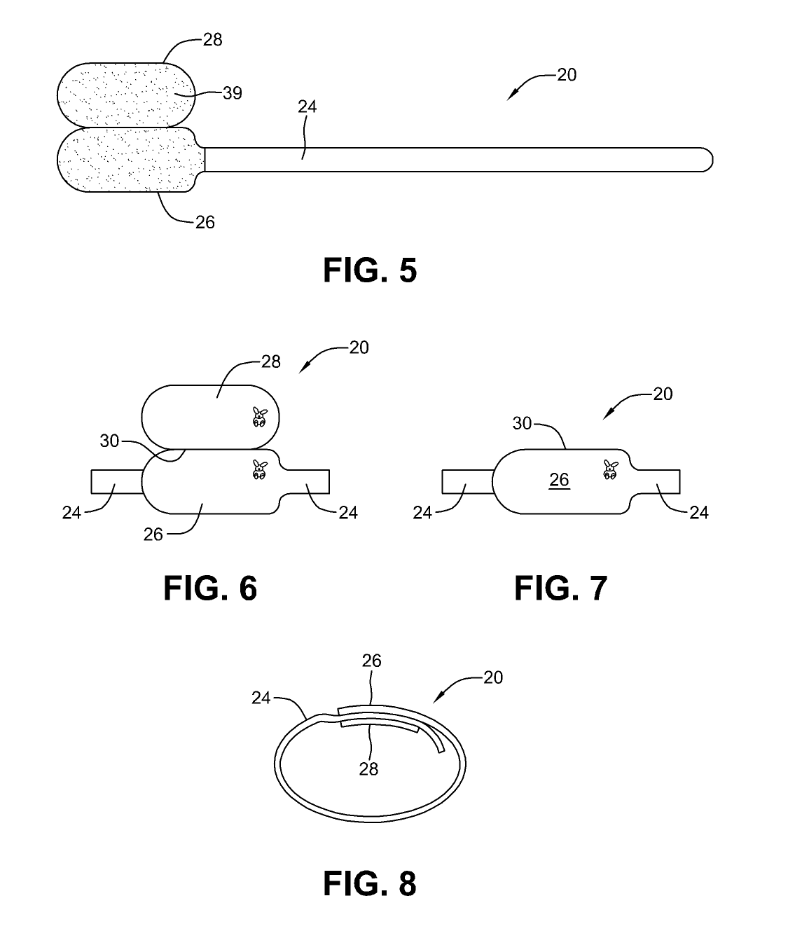

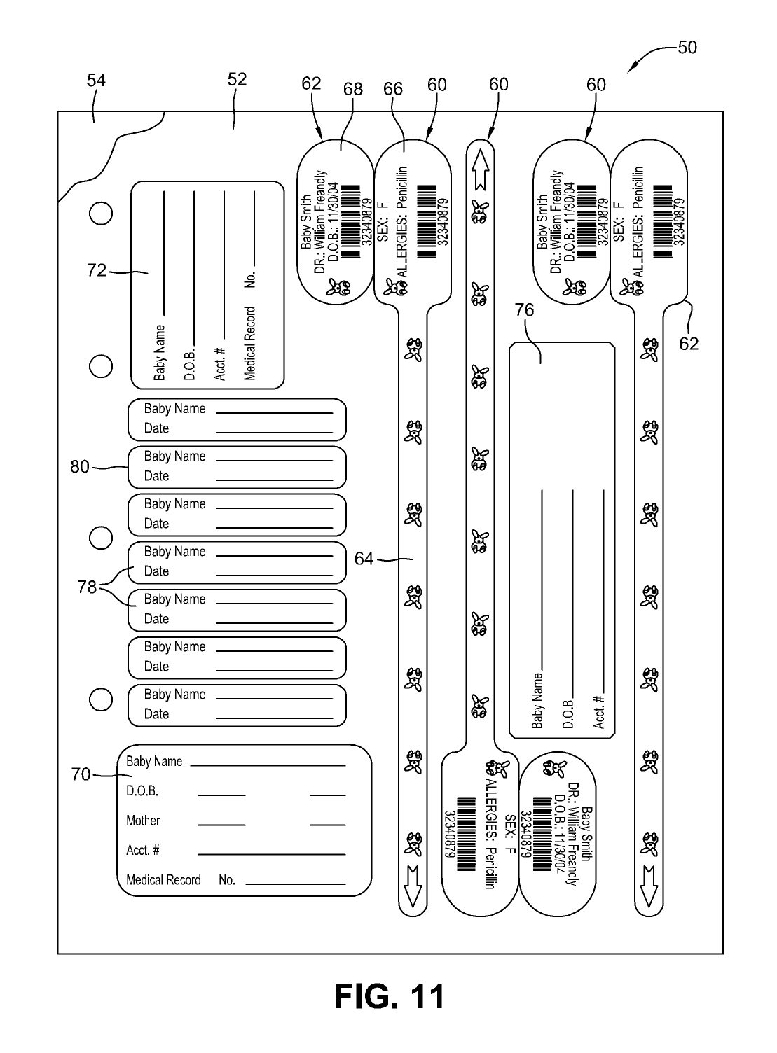

The sheet assembly 10 shown in FIGS. 1-3 is only one of many optional sheet configurations. An alternate sheet assembly is identified generally by the numeral 50 in FIG. 11. The sheet assembly 50 includes a face sheet 52 and a backing sheet 54. The sheet assembly includes a plurality of identification bands 60 that are substantially identical to the identification bands 20 described and illustrated with respect to FIGS. 1-8. Thus, each of the identification bands 60 is defined by a die cut array 62 to form a strap 64, an identification panel 66, and a flap 68. The portions of the back surface of the face sheet that are aligned with the strap have no coating thereon. However, the remainder of the back surface of the face sheet is coated with the above-described pressure sensitive adhesive 39. Portions of the top surface of the backing sheet registered with the identification panel and the flap have a release coating applied thereto. Portions of the backing sheet aligned with the strap have a low-tack adhesive applied thereto.

The sheet assembly 50 differs from the sheet assembly 10 by including a plurality of separate identification cards or tags 70, 72 and 76. In this embodiment, the identification card 70 is configured for insertion into a slot-like receptacle on an isolette. The identification cards 72 and 76 are dimensioned and configured for insertion respectively into pockets formed in a binder cover and a binder spine. The binder then can be used to retain records for a particular patient. As in the first embodiment, portions of the backing sheet 54 registered with the identification cards have no release coating and no low-tack adhesive applied thereto. Hence, the face sheet 52 and the backing sheet 54 permanently adhere to one another across the identification cards. Additionally, substantially registered die cut arrays extend through both the face sheet and the backing sheet around the respective peripheries of the identification cards. Thus, each identification cards can be separated from the sheet assembly with the backing sheet secured to the face sheet to provide adequate support for the identification cards.

The sheet assembly 50 also differs from the sheet assembly 10 by providing a plurality of labels 78. The labels are imprinted with identification indicia to identify, for example, the patient and the date. Each label is defined by a continuous array of die cuts 80 with dimensions comparable to the die cut arrays 22 of the first embodiment. Thus, each label can be severed from the remainder of the face sheet 52. Portions of the back surface of the face sheet corresponding to each label have a coating of the pressure sensitive adhesive 39 thereon. Portions of the top surface of the backing sheet 54 registered with the respective label have a release coating applied thereto substantially identical to the release coating registered with the identification panels and flaps 66 and 68. Thus, the labels can be separated from the remainder of the sheet assembly and applied to a substrate, such as a bottle of milk or formula.

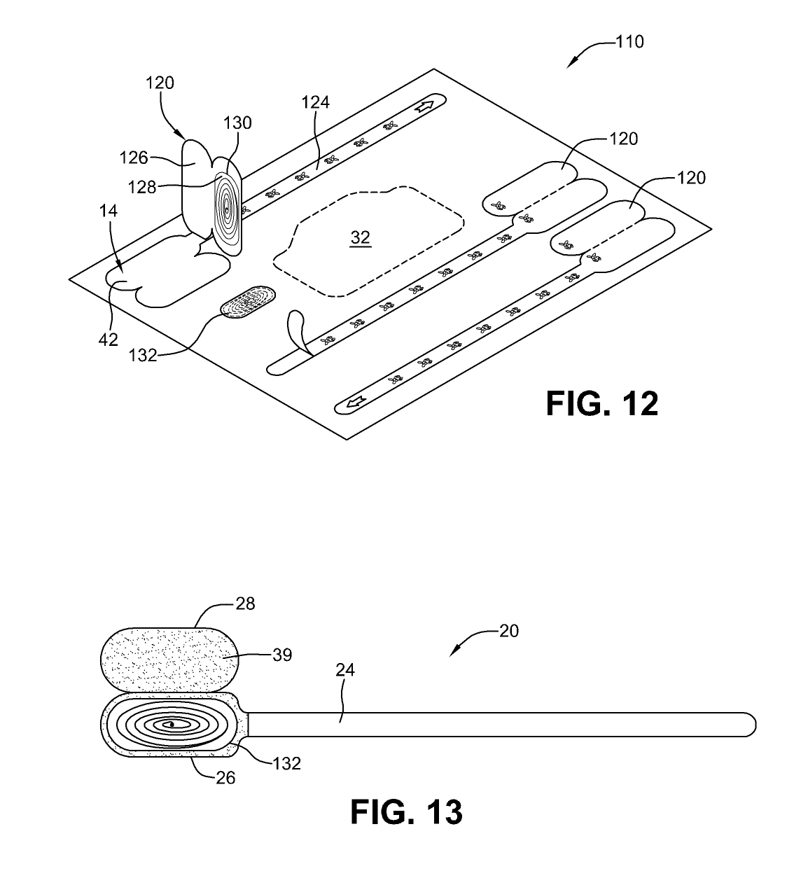

An alternate sheet assembly is illustrated in FIG. 12 and is identified generally by the numeral 110. The sheet assembly 110 is substantially identical to the sheet assembly 10 described and illustrated above. In particular, the sheet assembly 110 includes identification bands 120 each of which has a strap 124, an identification panel 126, and a flap 128. Additionally an RFID inlay 130 is adhered to the flap. As an alternate, the RFID inlay can be secured to the identification panel 126. With either of these options, the identification band will have the RFID inlay secured between the identification panel 126 and the flap 128 as the band is being mounted on the patient. FIG. 12 also shows an RFID label 132. The RFID label can be applied between the identification panel 26 and the flap 28, as shown in FIG. 13. Alternatively, the RFID label can be applied to the exterior of the identification panel 26 or the flap 28 so that the electronic aspects of the RFID label are beneath the portion of the RFID label defined by the face sheet 12. In all of these embodiments, the RFID inlay or the electronic aspect of the RFID label is safely, securely and permanently contained within the identification band 20 or 120. These optional designs permit secure tracking and monitoring of a patient as the patient moves through a healthcare facility. Additionally, the compressible nature of the woven fabric from which the identification band 20, 120 can be formed provides a protective cushion around the RFID inlay or label. Furthermore, the fabric of the identification band 20, 120 contributes to waterproofing of the RFID inlay or label.

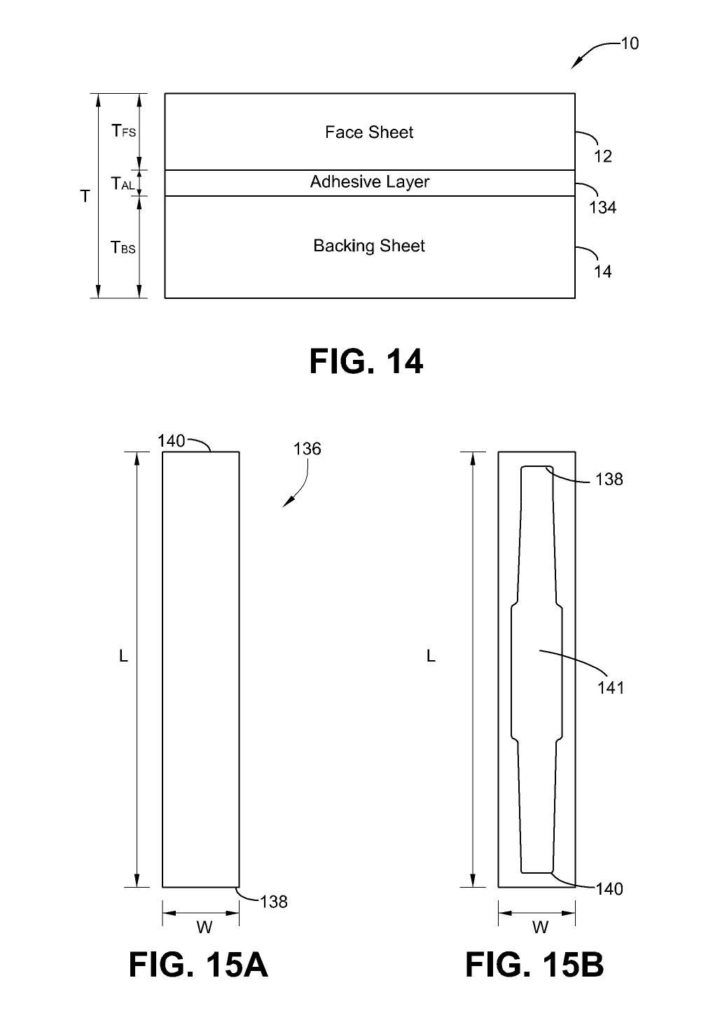

Referring additionally to FIG. 14, which is a general sectional view of the sheet assembly 10 shown in FIG. 1, the sheet assembly includes the following three layers: a face sheet 12, and underlying backing sheet 14 (also known to those having skill in the art as a liner), and a layer of adhesive 134 coupled between the face sheet and the backing sheet. The thickness of the face sheet “T_{FS}” can range in value from about 2 mils to about 5 mils, the thickness of the adhesive layer “T_{AL}” can range in value from about 0.5 mils to about 2 mils, and the thickness of the backing sheet “T_{BS}” can range in value from about 1.5 mils to about 6 mils. Accordingly, the overall thickness of the sheet assembly “T” can range in value from about 4 mils to about 13 mils. Various embodiments of the face sheet are discussed below. All of the face sheet embodiments discussed below can be combined with an adhesive layer and/or a backing sheet as previously discussed.

Another embodiment of the identification band 136 is shown in FIG. 15A. In this embodiment the identification band is a rectangular strip, which can be a portion of a sheet assembly, as previously discussed, or an individual item, which is not included in a sheet assembly. The identification band of FIG. 15A is configured to be wrapped around the wrist or ankle of a patient, and a portion of top surface of one end of the strip is placed in end-to-end engagement with a portion of the back surface of the strip. During attachment, adhesive on the back surface of one end 138 of the strip is exposed and coupled to the top surface of the other end 140 of the strip. The width “W” and length “L” of the strip can vary. In example embodiments, the width of the strip can range in value from about 0.25 inches to about 2 inches, and the length can range in value from about 4 inches to about 16 inches. Rectangular strip identification bands can be configured into sheets or rolls. In the additional embodiment of FIG. 15B, the identification band illustrated in FIG. 15A can be further subdivided into other identification bands 141 having shapes that are other than rectangular.

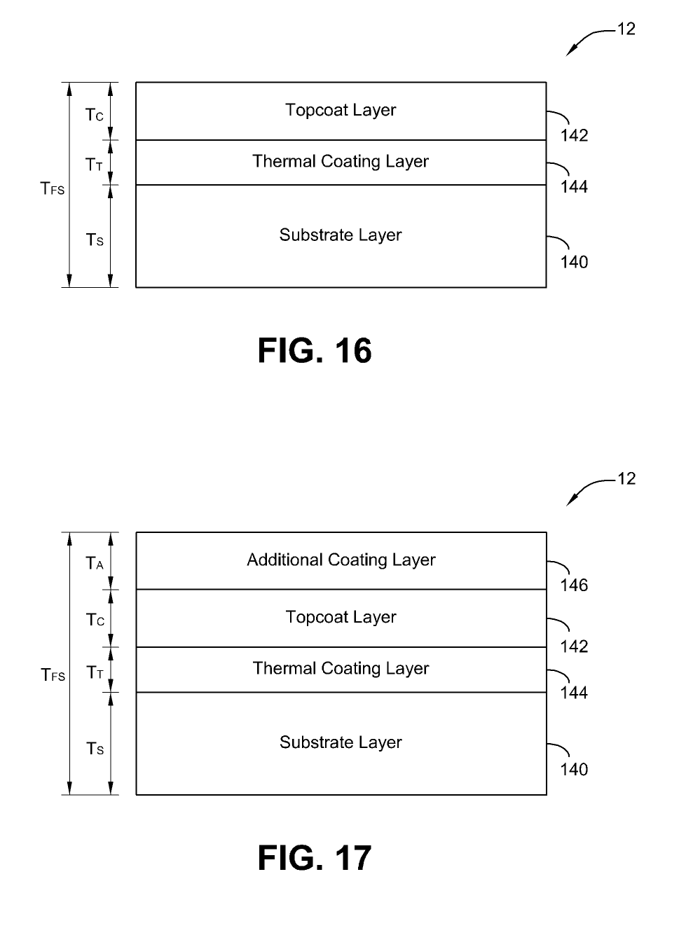

Referring additionally to FIG. 16, which is a sectional view of an example embodiment of a face sheet 12 that is configured to facilitate thermal printing, e.g., direct thermal printing. The face sheet includes the following three layers: a substrate layer 140, a topcoat layer 142, and a thermal coating layer 144 that is coupled between the substrate layer and the topcoat layer. If the face sheet is coupled to a backing sheet 14, the substrate layer is located between the thermal coating layer and the adhesive layer 14. The thickness of the substrate layer “T_{S}” can range in value from about 3.0 mils to about 4.0 mils, the thickness of the topcoat layer “T_{C}” can range in value from about 0.05 mils to about 0.5 mils, and the thickness of the thermal coating layer “T_{T}” can range in value from about 0.2 mils to about 1.6 mils. Accordingly, the overall thickness of the face sheet “T_{FS}” as shown in the embodiment of FIGS. 15A and 15B can range in value from about 3.25 mils to about 6.1 mils.

The substrate layer 140 can be made of various materials, for example, a woven material, a non-woven material, or a film. In embodiments where the substrate layer is made of a woven material, the woven material can be, for example, polyethylene terephthalate (“PET”), biaxially oriented polypropylene (“BOPP”), a 50 to 100 denier polyester, nylon, or a blend fabric, to which acrylic coatings can be applied to seal the sheet of material, e.g., woven material, and impart properties so the thermal coating layer 144 can be applied to it. The acrylic coatings are sufficiently crosslinked so the substrate layer's material can withstand fifty machine washings and maintain its durability. Examples of woven material, e.g., Worthen PS500W, that can be used in the substrate layer are available from, for example, Worthen Industries of Nashua, N.H.

As previously noted, non-woven material can be included in the substrate layer 140. Examples of the non-woven material can be manufactured from polyester, nylon, vinyl, polyolefin, polypropylene, and many other homopolymer or polymer blends. These non-woven materials can be sealed with crosslinked coatings that enable the non-woven material to bond to the thermal coating layer 144 or other layers (see later discussion), and to maintain the non-woven material's durability. Non-woven materials are available from Worthen Industries, e.g., Worthen TS-1147, Bostik Corp. of Middleton, Mass., and Hutchison Miller Sales Company of New Britain, Pa. Advantageously, there may be cost savings if the substrate layer is made of a non-woven material instead of a woven material, because non-woven materials tend to be less expensive than woven materials.

Examples of film materials that can be used in the substrate layer 140 include, for example, soft polymeric film materials that are available as commodity items from suppliers, for example, 4 Seasons/Granwell Corp. of Huntington, N.Y. offers POLYLITH AND TAIRILYN and Exxon Mobil Corporation of Irving, Tex. offers EXXTRAL, DIGILYTE, LABEL-LYTE, and OPPALYTE.

The thermal coating layer 144 is made of a material that facilitates thermal printing, e.g., direct thermal printing, of thermally-activated images or variable information, e.g., print and barcode information, within the face sheet 12. Thus, the thermal coating layer's material (also referred to as a direct thermally activatable material) is heat activatable. In general, the thermal coating layer is made of a low-solids water, a solvent, or a solventless borne liquid that includes a stoichiometric mixture of dye, sensitizer, and developer components. Example materials from which the thermal coating layer is made of are the following: NuCoat 8957 and 8952, which are provided by NuCoat of Plymouth, Minn. Example waterborne versions of the thermal coating layer material are about 30-50% solids. Example embodiments of the thermal coating layer material can include a leuco dye, a sensitizer, and a developer, which are intermixed and applied as a single coating to the substrate layer material.

Because the chemistry of the thermal coating layer's material typically is vulnerable to attack by alcohols, solvents, water, and/or other contaminants, a protective barrier coat, e.g., the topcoat layer 142, typically is applied over the thermal coating layer 144 to protect it. The topcoat layer is made of a material that is resistant to abrasion and chemical or other environmental contaminants, e.g., organic contaminants, inorganic contaminants, and biological fluids. Accordingly, the topcoat layer is a protective layer that prevents damage to, or contamination of, the thermal coating layer. The topcoat layer can be made of organic water, solvent, or solventless liquid(s), for example, solvent-borne acrylics or silicones, that can be dried or cured to develop its properties. Also, the topcoat layer can be UV curable. Examples of topcoat layer materials include the following: varnishes and other topcoat layer material provided by Acetega of Wesel, Germany, the Flint Group of Plymouth, Mich., and Ashland Inc. of Covington, Ky., for example, Acetega 814HSMW2 and Flint UVF02052. In example embodiments, the topcoat layer is applied with a coatweight in the range between about 5 grams per square meter and about 20 grams per square meter.

In addition to providing resistance to contaminants, the topcoat coating layer 142 also can be print-receptive to ink(s) and other medium. Referring additionally to FIG. 17, if the topcoat coating layer is not receptive to ink(s) or other medium, and such receptiveness is desired, an additional coating layer 146 can be applied over the topcoat layer, so the additional coating layer is coupled to the topcoat layer, to impart the desired properties. The additional coating layer has a thickness “T_{A},” which can range in value from about 0.05 mils to about 0.25 mils. Thus, the overall thickness “T_{FS}” of example embodiments of the face sheet 12 that include the additional coating layer with the substrate layer 140, the thermal coating layer 144, and the topcoat layer can range in value from about 3.3 mils to about 6.4 mils. The additional coating layer can be made from UV, or solvent-borne acrylics or silicones, and contain materials having abrasion-resistant properties, or other additives, depending on what finished performance properties are desired. An example of the material that can be used in the additional coating layer is varnish.

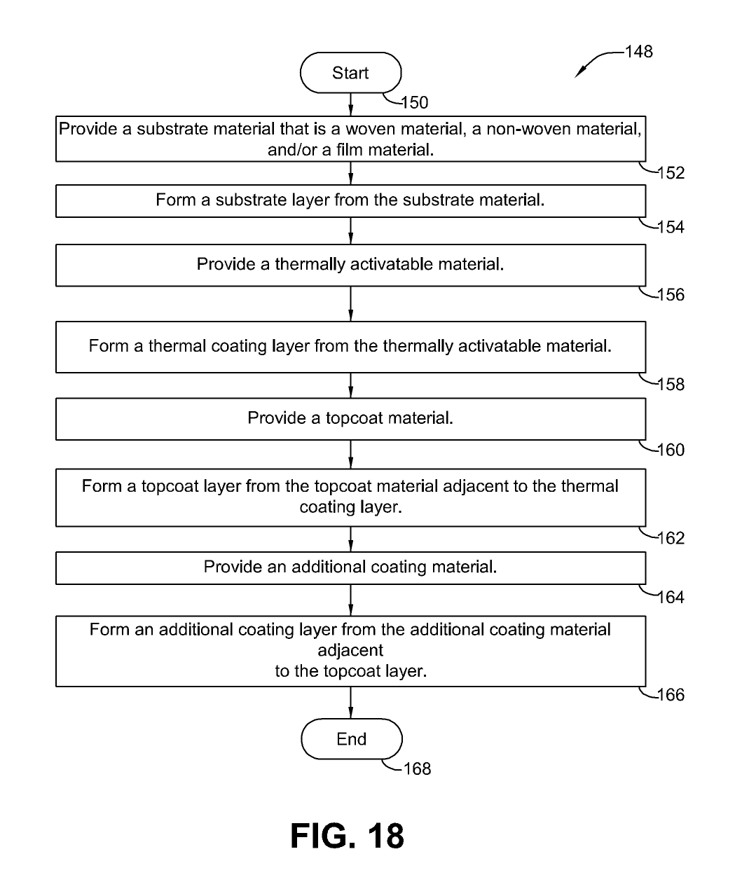

An exemplary method for forming a layer of face sheet 12 is illustrated in the flowchart 148 of FIG. 18. After starting the method at step 150, the next step 152 is to provide a substrate material, which can be a woven material, a non-woven material, and/or a film material. Next, at step 154, a substrate layer 140 is formed from the substrate material. At step 156, a thermally activatable material is provided. At step 158, a thermal coating layer 144, which is configured to facilitate thermal printing, is formed from the thermally activatable material. The thermal coating layer is formed adjacent to the substrate layer. The material of the thermal coating layer can be applied to the substrate layer using, for example, a press or a coater that utilizes, e.g., a rod, direct, or offset gravure, a flexographic print plate, a rotary screen, a slot die, a knife coater, a spray, or other conventional coating methods. Typical coatweights for the applied thermal coating layer material can range from about 10 grams per square meter to about 20 grams per square meter. In addition to fully coating the entire substrate layer, the material of the thermal coating layer can be applied in a variety of different patterns and shapes, which allow for cost-effective application of the thermal coating layer material only where it is needed. After application to the substrate layer, the thermal coating layer can be dried or cured using inline dryers or ovens to evaporate water or solvent that is included in the thermal coating layer's material.

Next, at step 160, a topcoat material is provided, which, at step 162, is used to form a topcoat layer 142 adjacent to the thermal coating layer 144. Oftentimes, the topcoat layer is deposited by a process, for example, gravure or reverse gravure processes, or via flexography. At step 164, an additional coating material is provided. At step 166, an additional coating layer 146 is formed from the additional coating material adjacent to the topcoat layer. The method ends at step 168.

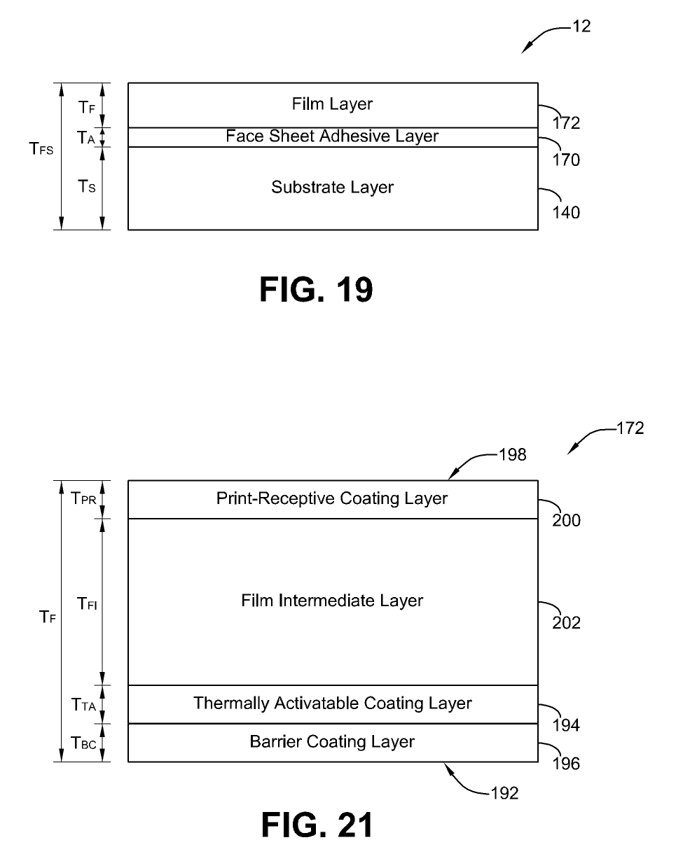

Referring additionally to FIG. 19, in additional embodiments, the face sheet 12 includes the following: a substrate layer 140, a face sheet adhesive layer 170, and a film layer 172, which is coupled to the substrate layer via the face sheet adhesive layer. If the face sheet is coupled to a backing sheet 14, the substrate layer is located between the adhesive layer 134 and the face sheet adhesive layer 170. The substrate layer in the embodiment of FIG. 19 can be made of woven, non-woven, or film materials, as previously discussed. The film layer 172 includes a direct thermal coated film, i.e., the film facilitates direct thermal printing. Accordingly, the topcoat layer 142 and thermal coating layer 144, as shown in the embodiment of FIG. 16, are replaced with the film layer 172 and the face sheet adhesive layer 170. The film layer can have a thickness “T_{F}” that ranges in value from about 0.2 mils to about 1.6 mils. The face sheet adhesive layer can have a thickness “T_{A}” that ranges in value from about 0.5 mils to about 2.0 mils. Accordingly, the overall thickness “T_{FS}” of the embodiment of the face sheet shown in FIG. 19 can range in value from about 3.7 mils to about 7.6 mils.

The material from which the film layer 172 is formed can be a clear polyester or polypropylene film that is thermally activatable. Examples of the film layer material are THERMALLY OVER-LAMINATING FILM (“TOF”), TF-100™ and TF-160™, which are manufactured by International Imaging Materials, Inc. (“IIMAK Inc.”) of Amherst, N.Y. The material from which the film layer is made is soft, and similar in softness to woven material, which can be used in the substrate layer 140.

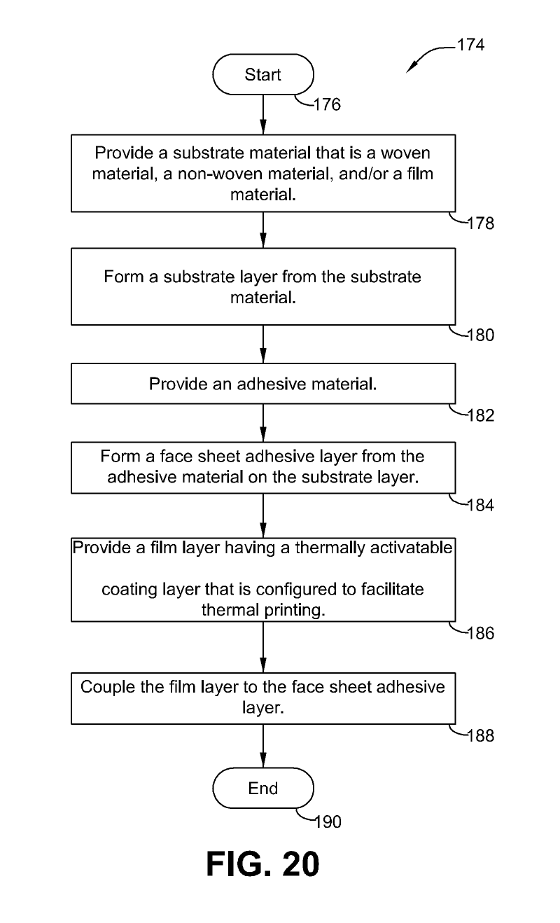

An exemplary method for forming a layer of face sheet 12 that includes the film layer 172 according to the present invention is illustrated in the flowchart 174 of FIG. 20. After starting the method at step 176, the next step 178 is to provide a substrate material, which can be a woven material, a non-woven material, and/or a film material. Next, at step 180, the substrate layer 140 is formed from the substrate material. At step 182, an adhesive material is provided, which is in turn formed into a face sheet adhesive layer on the substrate at step 184. At step 186, a film layer is provided. At step 188, the film layer is coupled to the face sheet adhesive layer. The method ends at step 190.

In comparison to the embodiments shown in FIGS. 15A, 15B, 16, and 17, a topcoat layer 142 need not be applied over the underlying layers of the face sheet 12 in the face sheet embodiment of FIG. 19, because the film layer 172 already provides protection from the environment, e.g., water, alcohols, body fluids, etc. In particular, and referring additionally to the embodiment of a film layer illustrated in FIG. 21, the film layer, on the surface 192 that is positioned adjacent to the face sheet adhesive layer 170 includes the thermally activatable coating layer 194 and a barrier layer 196, which helps prevent the adhesive material from the underlying face sheet adhesive layer from reacting and interfering with the thermally activatable coating layer's imaging capabilities. The opposite surface 198 of the film layer can include a print-receptive coating layer 200. In between the print-receptive layer and the thermally activatable coating layer is a film intermediate layer 202. The print-receptive coating layer can have a thickness “T_{PR}” that ranges in value from about 0.02 mils to about 0.2 mils. The film intermediate layer can have a thickness “T_{FI}” that ranges in value from about 0.1 mils to about 0.5 mils. The thermally activatable coating layer can have a thickness “T_{TA}” that ranges in value from about 0.02 mils to about 0.2 mils. The barrier coating layer can have a thickness “T_{BC}” that ranges in value from about 0.02 mils to about 0.2 mils.

The print-receptive coating layer 200 can applied via gravure or reverse gravure processes, or flexography processes. The film intermediate layer 202 can be made of, for example, a polypropylene or some other blended polyolefin or multiple film laminations. The thermally-activatable coating layer 194, which is configured to facilitate thermal printing, e.g., direct thermal printing, can be made of, for example, the previously discussed materials that were used in the thermal coating layer 144, which can be applied using gravure or reverse gravure processes, or meyer rod or other coating technologies. Similarly, the barrier coating layer 196 can be applied using gravure or reverse gravure processes, or meyer rod or other coating technologies.

Advantageously, the film layer 172 is coupled to the substrate layer 140 in an orientation so the thermally activatable coating layer 194 and the barrier carrier layer 196 are adjacent to the face sheet adhesive layer 170 and the substrate layer 140, and thus, the rest of the film layer protects the thermally activatable coating layer from exposure. Accordingly, this configuration allows the film intermediate layer 202 to protect the thermally activatable coating layer from water, chemicals, etc. Also, because the thickness of the film layer “T_{F}” is thin, this configuration provides good thermal imaging.

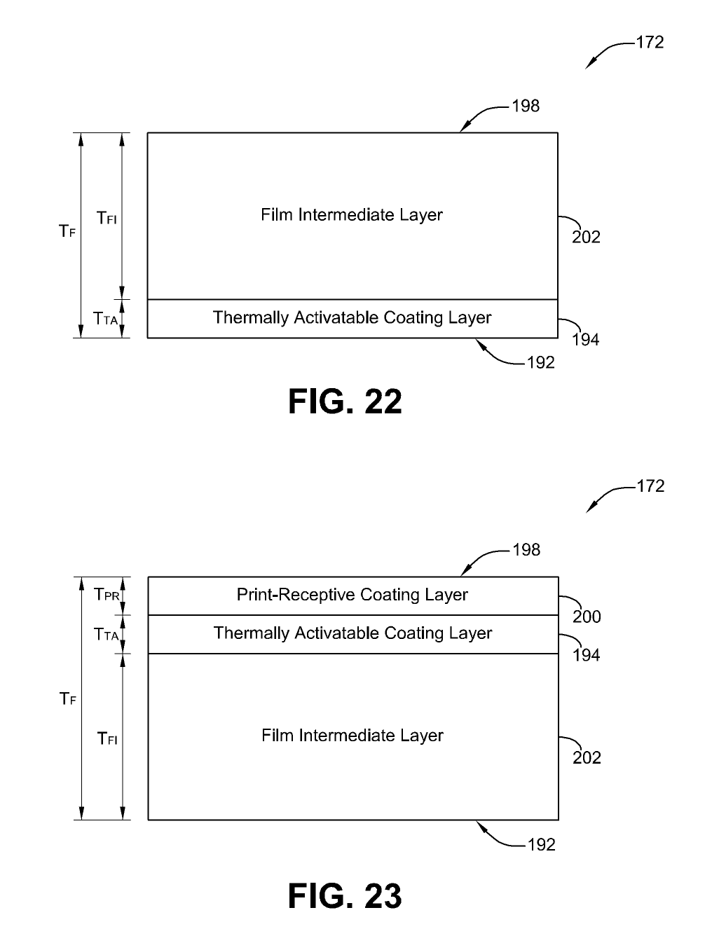

Referring additionally to FIG. 22, in another embodiment, the film layer 172 does not include the print-receptive coating layer 200 or the barrier coating layer 196. In the embodiment of FIG. 22, the thermally activatable coating layer 194 is coupled between the film intermediate layer 202 and the face sheet adhesive layer 170.

Referring additionally to FIG. 23, in yet another embodiment, the film layer 172 does not include a thermally activatable coating layer 194 and a barrier coating layer 196 between the face sheet adhesive layer 170 and the film intermediate layer 202, or a print-receptive coating layer 200. Rather, the film intermediate layer is coupled to the face sheet adhesive layer, and a print-receptive coating layer 200 and a thermally activatable coating layer 194 are located above the film intermediate layer, on the side of the film intermediate layer opposite the face sheet adhesive layer. In the embodiment of FIG. 23, no barrier coating layer is located between the face sheet adhesive layer and the thermally activatable coating layer because the intermediate film layer is located between the face sheet adhesive layer and the thermally activatable coating layer.

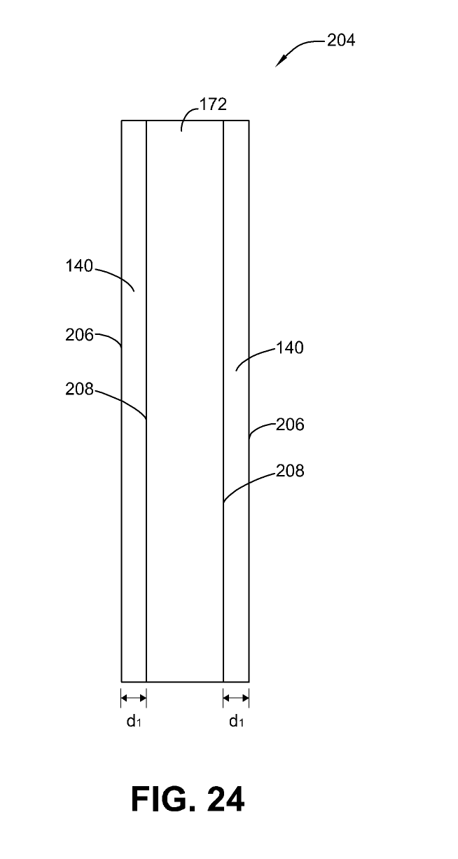

In additional embodiments, the substrate layer 140 extends beyond the film layer 172. In FIG. 24, which is a top plan view of an example embodiment of an identification band 204 where the substrate layer 140 extends a distance “d₁” beyond the extent of the film layer 172 along both edges 206 of the identification band. While FIG. 24 illustrates the substrate layer extending beyond the film layer along two edges, in other embodiments, the substrate layer extends beyond the film layer along only one edge, along three edges, or along all four edges of the identification band. In additional embodiments, the substrate layer extends beyond the film layer along only a portion(s) of one or more edges of the identification band. Also, the distance that the substrate layer extends beyond the film layer need not be uniform along a single edge of the identification band, and the distance can be different along one edge of the identification band in comparison to another edge of the identification band. The extension of one or more the edges of the substrate layer beyond the extent of the film layer softens the edge 208 of the film layer and imparts upon a person that touches the edge of the identification band the perception that the identification band has a soft edge. The strength of this perception is controlled by varying the distance, e.g., d₁, of the extent of the substrate layer beyond the film layer.

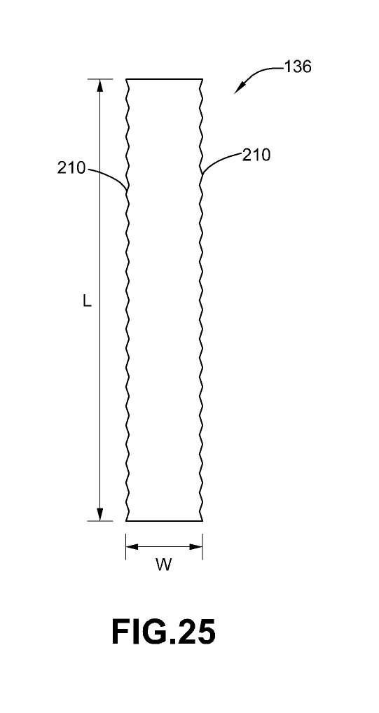

Referring additionally to FIG. 25, in embodiments, the rectangular strip identification band 136 can have one or more edges 210 that have been cut, textured, or serrated, to make one or more of the edges uneven, and to give one or more of the edges a softer feel. These cut, textured, or serrated edges can be in the edge(s) of the substrate layer 140 that extends beyond the film layer 172, as previously discussed in the context of the embodiment of FIG. 24, or the cut, textured, or serrated edges 210 can be in both the substrate layer and the film layer, even in the embodiments where substrate layer does not extend beyond the film layer, i.e., the width of the film layer is the same as the width of the substrate layer. The cut, textured, or serrated edges need not be uniform along the edge, and can be cut using, for example, die cutting.

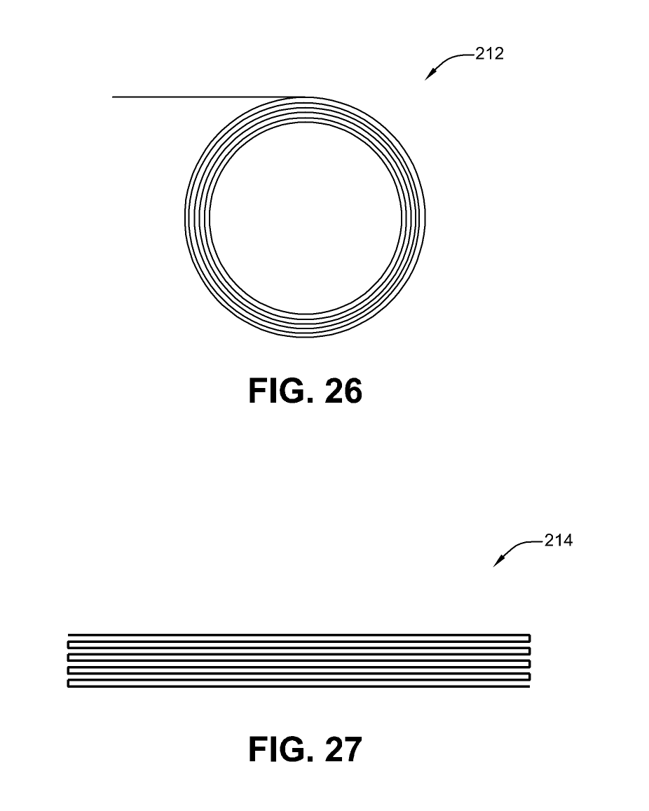

During use, the present invention includes direct thermally activatable material that can be used in a variety of products/items, including, for example, patient identification wristbands 20, 120, and 136, identification cards 32, 70, 72, and 76, and labels 78 from which the material is converted. The items that include the direct thermally activatable material can also include an RFID component, e.g., an RFID inlay 130 or an RFID label 132. In the example of a patient identification band, only a piece or portion of the face sheet 12, i.e., not an entire sheet of the face sheet, in combination with a corresponding piece or portion of the backing sheet 14 are utilized to form the identification band. The direct thermally activatable materials can be incorporated into a sheet assembly 10 that is configured to be fed through a printer, for example, a direct thermal printer. While the previously discussed embodiment of the direct thermally activatable material is in a sheet format, individuals having skill in the art should understand that the direct thermally activatable material can be included in face sheet that is part of a roll of material 212 or a fan-folded stack of sheets 214 of material (see FIGS. 26 and 27, respectively).

Advantageously, embodiments of the present invention result in a soft face sheet 12 that can be used in patient identification bands 20, 120, and 136 thus, providing patients with added comfort in comparison to current patient identification bands that are significantly stiffer, and accordingly, can abrade, chafe, or otherwise adversely affect a patient's skin. Also, the embodiments allow for direct thermal printing while protecting the layer 144 and 194 of the material that is responsible for direct thermal printing from environmental contamination/damage.

While the invention has been described with respect to a preferred embodiment, it is apparent that changes can be made without departing from the scope of the invention as defined by the appended claims. For example, the laminated sheet assembly 10 can have only one identification band 20, 120, and 136 or more than the three identification bands illustrated herein. Additionally the illustrated identification card 32, 70, 72, and 76 may not be required in all embodiments, or the above-described identification cards can be labels 78. Alternatively labels may or may not be included in the laminated sheet assembly. Labels can be provided for application to files, vials or other structures. For these situations, a release coating can be applied to the top surface 40 of the backing sheet 14 at locations registered with the labels. The labels can be defined by die cut arrays 80 and can have adhesive coating 39 applied to the rear surface of the face sheet. Thus, labels can be peeled from the backing sheet and separated from one another and from remaining portions of the face sheet for application to appropriate supports.

The embodiments described and illustrated above are intended primarily for use with infants. The invention, however, is particularly well suited for geriatric and other adult applications. In these situations, the identification band may be longer and wider. Still further, the identification panel 26 and 126 and the flap 28 and 128 may be formed separately from the strap 24 and 124 and may function effectively as a fabric clasp for holding opposed portions of the strap in face-to-face relationship to one another. This is particularly well suited for embodiments of the identification band mounted in the form of a flag.

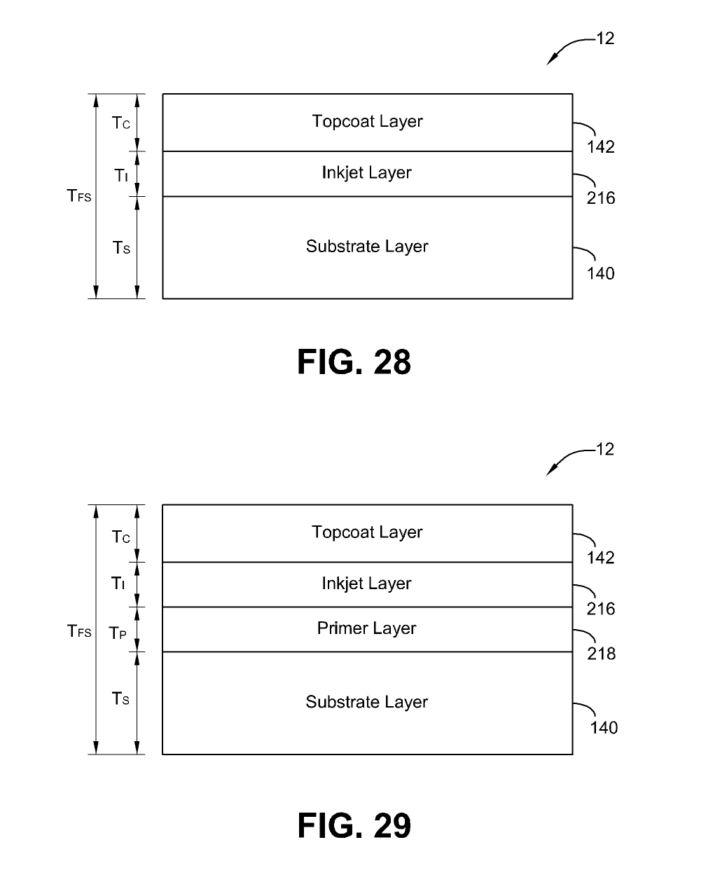

In other embodiments, the face sheet 12 is configured to facilitate inkjet printing. In these inkjet printing embodiments, the thermal coating layer 144 (e.g., see FIG. 16) is replaced with a) a layer of inkjet material 216 (see FIG. 28) or b) a layer of inkjet material and a layer of primer 218 (see FIG. 29), which is located between the layer of inkjet material and the substrate layer 140. Examples of the inkjet material include NuCoat's 8418 product and Ontario Specialty Coating Corporation's (of Watertown, N.Y.) C-127-3 product. The layer of inkjet material and/or the substrate layer can be deposited using, for example, gravure, reverse gravure, meyer rod, flexography, or other known coating technology(ies). In these embodiments, the topcoat layer has a thickness “T_{C},” which can range in value from about 0.02 mil to about 0.2 mil; the inkjet layer has a thickness “T_{I},” which can range in value from about 0.02 mil to about 0.2 mil; the primer layer (if present) has a thickness “T_{P},” which can range in value from about 0.02 mil to about 0.2 mil; and the substrate layer has a thickness “T_{S},” which can range in value from about 1 mil to about 5 mil. Accordingly, the scope of the invention is defined only by the following claims.

What is claimed is:

1. A face sheet comprising:
a. a substrate layer; and
b. a layer that is coupled to the substrate layer, and is configured to facilitate printing selected from the group consisting of thermal printing and inkjet printing;
c. wherein the substrate layer is made of a material selected from the group consisting of a woven material, a non-woven material, and a film material.

2. The face sheet according to claim 1, wherein the face sheet is characterized as having a soft texture.

3. The face sheet according to claim 1, wherein the substrate layer material is selected from the group consisting of polyethylene terephthalate, a biaxially oriented polypropylene, a vinyl, a polyolefin, a polyester, a nylon, or a blend thereof.

4. The face sheet according to claim 1, wherein the layer that is configured to facilitate printing is an inkjet layer.

5. The face sheet according to claim 1, wherein the layer that is configured to facilitate printing is a thermal coating layer.

6. The face sheet according to claim 5, wherein:
a. the thermal coating layer is made of a liquid that is selected from the group consisting of a low-solids water, a solvent borne liquid, and a solventless borne liquid; and
b. the liquid includes a mixture of a dye, a sensitizer, and a developer.

7. The face sheet according to claim 4, further comprising a topcoat layer that is coupled to the layer that is configured to facilitate printing with the layer that is configured to facilitate printing coupled between the topcoat layer and the substrate layer.

8. The face sheet according to claim 7, wherein the topcoat layer is made of a material that is selected from the group consisting of water, a solvent liquid, a solventless liquid, a solvent-borne acrylic, and a solvent-borne silicone.

9. The face sheet according to claim 7, further comprising an additional coating layer that is coupled to the top coat layer with the topcoat layer coupled between the additional coating layer and the layer that is configured to facilitate printing.

10. The face sheet according to claim 9, wherein the additional coating layer is made of a material that is selected from the group consisting of a water-based material, a solvent-borne acrylic, and a solvent-borne silicone.

11. The face sheet according to claim 9, wherein the coating layer is UV curable.

12. The face sheet according to claim 1, further comprising a primer layer that is coupled between the substrate layer and the layer that is configured to facilitate printing.

13. The face sheet according to claim 1, wherein:
a. the face sheet further includes a film layer; and
b. the layer that is configured to facilitate printing is included in the film layer.

14. The face sheet according to claim 13, further comprising a face sheet adhesive layer that is coupled between the film layer and the substrate layer.

15. The face sheet according to claim 13, wherein the film layer is made of a material selected from the group consisting of a polyester, a polypropylene, TF-100™, and TF-160™.

16. The face sheet according to claim 13, wherein:
a. the layer that is configured to facilitate printing is a thermally activatable coating layer; and
b. the film layer includes another layer selected from the group consisting of a print-receptive coating layer and a barrier coating layer.

17. The face sheet according to claim 1, wherein the substrate layer extends beyond the layer that is coupled to the substrate.

18. The face sheet according to claim 1, wherein the face sheet is part of an item that is selected from the group consisting of an identification band, an identification card, a label, and a tag.

19. The face sheet according to claim 18, wherein the item includes an RFID component that is selected from the group consisting of an RFID inlay and an RFID label.

20. The face sheet according to claim 1, wherein:
a. the face sheet is part of an identification band; and
b. the identification band has at least one edge that is uneven.

21. The face sheet according to claim 1, wherein the face sheet is configured into an item selected from the group consisting of a sheet, a z-fold stack of sheets, and a roll of material.

22. An identification band comprising:
a. a piece of face sheet having:
i. a substrate layer, and
ii. a layer that is coupled to the substrate layer, and is configured to facilitate printing selected from the group consisting of thermal printing and inkjet printing,
iii. wherein the substrate layer is made of a material selected from the group consisting of a woven material, a non-woven material, and a film material;
b. a piece of backing sheet; and
c. a layer of adhesive that is coupled between the piece of face sheet and the piece of backing sheet.

23. The identification band according to claim 22, wherein the piece of face sheet is characterized as having a soft texture.

24. The identification band according to claim 22, wherein the layer that is configured to facilitate thermal printing is a thermal coating layer.

25. The identification band according to claim 24, further comprising a topcoat layer that is coupled to the thermal coating layer with the thermal coating layer coupled between the topcoat layer and the substrate layer.

26. The identification band according to claim 22, wherein:
a. the piece of face sheet further comprises a film layer; and
b. the layer that is configured to facilitate thermal printing is included in the film layer.

27. The identification band according to claim 22, wherein the substrate extends beyond the layer that is coupled to the substrate layer.

28. The identification band according to claim 22, further comprising an RFID component that is selected from the group consisting of an RFID inlay and an RFID label.

29. A method for forming a face sheet, the method comprising:
a. providing a substrate material;
b. providing a second material selected from the group consisting of a thermally activatable material and an inkjet material;
c. forming a substrate layer from the substrate material; and
d. forming a second layer from the second material;
e. wherein:
i. the second layer is adjacent to the substrate layer,
ii. the second layer is configured to facilitate printing, and
iii. the substrate material is selected from the group consisting of a woven material, a non-woven material, and a film material.

30. The method according to claim 29, wherein the step of forming the second layer from the second material includes depositing the second material on the substrate layer.

31. The method according to claim 29, further comprising:
a. providing a topcoat material; and
b. forming a topcoat layer from the topcoat material adjacent to the second layer.

32. The method according to claim 31, further comprising:
a. providing an additional coating material; and
b. forming an additional coating layer from the additional coating material adjacent to the topcoat layer.

33. A method for forming a face sheet, the method comprising:
a. providing a substrate material;
b. forming a substrate layer from the substrate material;
c. providing a film layer having a thermally activatable coating layer; and
d. coupling the film layer to the substrate layer;
e. wherein:
i. the thermally activatable coating layer is configured to facilitate thermal printing, and
ii. the substrate material is selected from the group consisting of a woven material, a non-woven material, and a film material.

34. The method according to claim 33, wherein the step of coupling the film layer to the substrate layer includes:
a. providing an adhesive material;
b. forming an adhesive layer from the adhesive material; and
c. coupling the adhesive layer between the film layer and the substrate layer.
